(19) United States
(12) Patent Application Publication
(10) Pub. No.: US 2013/0268805 A1
(43) Pub. Date: Oct. 10, 2013

(54) MONITORING SYSTEM AND METHOD

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); CHIEN-FA YEH, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/726,534

(22) Filed: Dec. 24, 2012

(30) Foreign Application Priority Data
Apr. 9, 2012 (CN) 201210100903.8

(51) Int. Cl. G06F 11/07

(52) U.S. Cl. CPC G06F 11/0793
USPC 714/15

(57) ABSTRACT

A remote computer monitors virtual machines in cloud servers of a data center. The remote computer sends a monitoring program to cloud servers according to a configuration file and consists of a cloud server cluster using the monitoring program. The remote computer obtains parameters of each cloud server from the cloud server cluster by the monitoring program. The remote computer searches for an image file corresponding to a virtual machine installed in the cloud server from the remote computer, if the cloud server works abnormally. The remote computer sends the searched image file to another cloud server in the cloud server cluster and installs the virtual machine in another cloud server according to the searched image file.

### BACKGROUND

1. Technical Field

Embodiments of the present disclosure relate to monitoring technology, and particularly to a system and method for monitoring virtual machines in cloud servers of a data center.

2. Description of Related Art

A virtual machine (VM) is a software implementation of a machine (a computer or a server) on an operating system (kernel) layer. By using the VM, multiple operating systems can co-exist and run independently on the same computer. However, if the computer works abnormally (e.g., crash or frozen), the virtual machines may need to be reinstalled. In such situation, the virtual machines are manually reinstalled, this is inconvenient and inefficient. Also tedious and time-consuming and thus, there is room for improvement in the art.

### BRIEF DESCRIPTION OF THE DRAWINGS

FIG. 1 is a schematic block diagram of one embodiment of a monitoring system.

FIG. 2 is a block diagram of one embodiment of a remote computer included in FIG. 1.

FIG. 3 is a flowchart of one embodiment of a monitoring method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

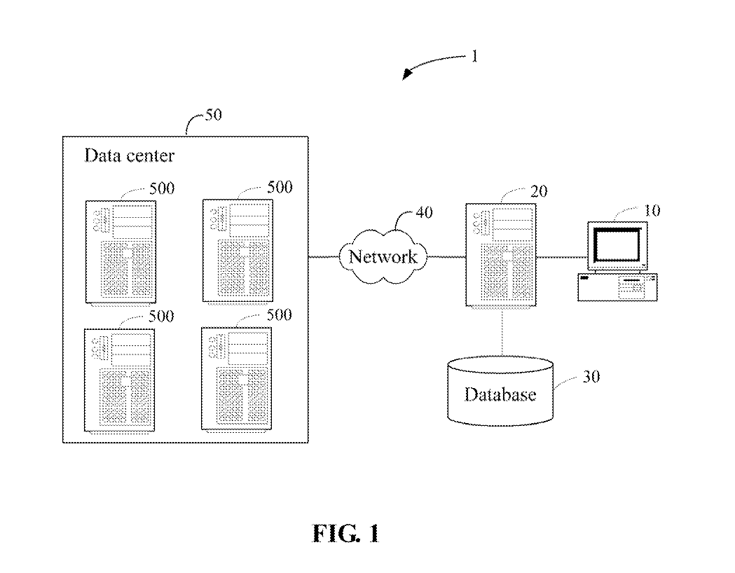

FIG. 1 is a system view of one embodiment of a monitoring system 1. In one embodiment, the monitoring system 1 may include a remote computer 20 and a data center 50. The data center 50 is designed for cloud computing capability and capacity including a plurality of cloud servers 500. The remote computer 20 is connected to the data center 50 via a network 40. The network 40 may be, but is not limited to, a wide area network (e.g., the Internet) or a local area network. The monitoring system 1 may be used to monitor virtual machines in each of the cloud servers 500. Using open database connectivity (ODBC) or java database connectivity (JDBC), for example, the remote computer 20 connects to a database system 30. The database system 30 may store data which is sorted by the remote computer 20. Additionally, each of the one or more client computers 10 provides an operation interface for controlling one or more operations of the remote computer 20.

The remote computer 20 stores one or more image files. Each image file is defined as a compressed file that contains complete contents and structures of an operating system. Each image file includes an installation process of a virtual machine and an activation process of the virtual machine. In one embodiment, if the image file is deployed into the cloud servers 500, then the virtual machine is installed into the cloud servers 500 and is activated to be available for use. In other words, a user can use the image file to install one or more virtual machines in the cloud servers 500.

The image file consists of a set of attributes that define a virtual machine. The set of attributes can be used repeatedly to create the one or more virtual machines having the set of attributes. The set of attributes may include capacity of a virtual machine (e.g., amount of RAM required for the virtual machine, a percentage of CPU required for the virtual machine, and a number of virtual CPUs), operating system vector attributes (e.g., CPU architecture to virtualization, a path to the kernel to boot the image file, a boot device type), disk vector attributes (e.g., a disk type, a size, a file system type), network vector attributes (e.g., a name of the network, an ID of the network, internet protocol, a MAC address, a bridge). In one embodiment, the image file may be, but is not limited to, a VMWARE ESX, or a WINDOWS SERVER 2008.

The remote computer 20 further stores a virtual machine controlling application. The virtual machine controlling application is defined as a software application that deploys the one or more image files in the cloud servers 500. The virtual machine controlling application may be, but is not limited to, a VMWARE VCENTER.

In order to manage the one or more virtual machines, each cloud server 500 installs a virtual machine management application (e.g., HYPERVISOR). The virtual machine management application is used to manage and monitor execution of the one or more virtual machines. The virtual machine management application obtains a CPU utilization rate (e.g., 80%, a percentage capacity usage of a CPU) of each cloud server 500. Additionally, the virtual machine management application also obtains a serial number of each cloud server 500, a voltage of the cloud server 500, a rotational speed of a fan of the cloud server 500, a temperature of the cloud server 500, a status of the cloud server 500 (e.g., power on/off).

The remote computer 20, in one example, can also be a dynamic host configuration protocol (DHCP) server, which provides a DHCP service. In one embodiment, the remote computer 20 assigns Internet protocol (IP) addresses to the cloud servers 500 using the DHCP service. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address to the cloud server 500. In one embodiment, the remote computer 20 may be a personal computer (PC), a network server, or any other data-processing equipment which can provide IP address allocation function.

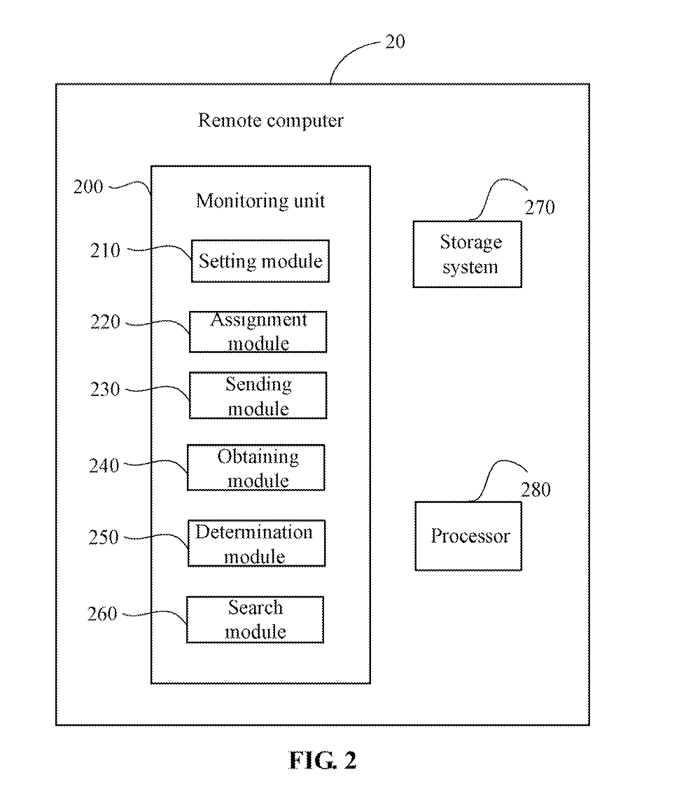

FIG. 2 is a block diagram of one embodiment of the remote computer 20. The remote computer 20 includes a monitoring unit 200. The monitoring unit 200 may be used to monitor the virtual machine in the cloud servers 500. The remote computer 20 includes a storage system 270, and at least one processor 280. In one embodiment, the monitoring unit 20 includes a setting module 210, an assignment module 220, a sending module 230, an obtaining module 240, a determination module 250 and a search module 260. The modules 210-260 may include computerized code in the form of one or more programs that are stored in the storage system 270. The computerized code includes instructions that are executed by the at least one processor 280 to provide functions for the modules 210-260. The storage system 270 may be a memory, such as an EPROM, hard disk drive (HDD), or flash memory.

The setting module 210 sets a configuration file and a monitoring program, and stores the configuration file and the monitoring program in the remote computer 20. Each cloud server 500 corresponds to a serial number. The configuration file includes serial numbers of the cloud servers 500 (at least two cloud servers 500). The monitoring program is installed in the cloud server 500 according to the configuration file. For example, if the configuration file includes four serial numbers of the cloud servers 500, namely A, B, C and D, the monitoring program is installed in the cloud servers A, B, C and D. The monitoring program obtains the CPU utilization rate of the cloud server 500, the voltage of the cloud server 500, the rotational speed of the fan of the cloud server 500, the temperature of the cloud server 500, the status of the cloud server 500 from the virtual machine management application.

The assignment module 220 assigns an IP address by the DHCP service to each cloud server 500 of the data center 50 to communicate with each cloud server 500.

The sending module 230 sends the monitoring program to the cloud servers 500 according to the configuration file and consists of a cloud server cluster. For example, if the configuration file includes four serial numbers of the cloud servers 500, namely A, B, C and D, the sending module 230 sends the monitoring program to the cloud servers A, B, C and D. The monitoring program is installed into the cloud servers A, B, C and D and is activated to be available for use in the cloud servers A, B, C and D. The cloud server cluster is defined that each two of the cloud servers 500 are capable of directly communicating with each other using the monitoring program.

The obtaining module 240 obtains parameters of each cloud server 500 in the cloud server cluster by the monitoring program. The parameters of each cloud server 500 include the CPU utilization rate of the cloud server 500, the voltage of the cloud server 500, the rotational speed of the fan of the cloud server 500, the temperature of the cloud server 500, and the status of the cloud server 500. In one embodiment, the monitoring program obtains the parameters of each cloud server 500 in the cloud server cluster from the virtual machine management application.

The determination module 250 determines if each cloud server 500 in the cloud server cluster works abnormally according to the parameters. The cloud server 500 works abnormally upon the condition that the CPU utilization rate of the cloud server 500 does not fall within a predetermined CPU utilization rate range (e.g., 20%˜80%). For example, if the cloud server 500 is frozen, the CPU utilization rate of the cloud server 500 may be 100%, the cloud server 500 works abnormally. The cloud server 500 works abnormally upon the condition that the voltage of the cloud server 500 does not fall within a predetermined voltage range (e.g., 10 volts (V)−30 V), or the obtained rotational speed of the fan of the cloud server 500 does not fall within a predetermined rotational speed range (e.g., 1000 revolutions per minute (rpm)−5000 rpm), or the temperature of the cloud server 500 does not fall within a temperature range (20 Celsius degrees−30 Celsius degrees), or the cloud server 500 is in a power-off state.

The search module 260 searches for the image file corresponding to the virtual machine installed in the cloud server 500 from the remote computer, if the cloud server 500 works abnormally.

The sending module 230 sends the searched image file to another cloud server 500 in the cloud server cluster and installs the virtual machine in another cloud server 500 according to the searched image file. For example, if the cloud server A works abnormally, the sending module 230 sends the searched image file to the cloud server B, and install the virtual machine in the cloud server B according to the searched image file. In one embodiment, the sending module 230 uses virtual machine controlling application to send the searched image file to another cloud server 500 in the cloud server cluster.

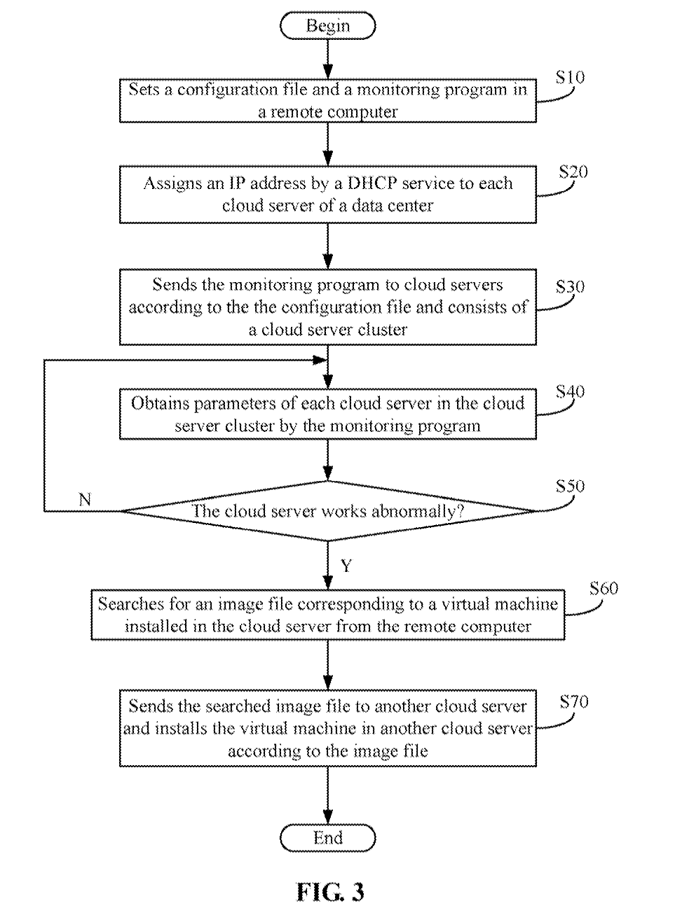

FIG. 3 is a flowchart of one embodiment of a monitoring method. Depending on the embodiment, additional steps may be added, others deleted, and the ordering of the steps may be changed.

In step S10, the setting module 210 sets a configuration file and a monitoring program, and stores the configuration file and the monitoring program in the remote computer 20. As mentioned above, the monitoring program is installed in the cloud server 500 according to the configuration file. For example, if the configuration file includes four serial numbers of the cloud servers 500, named A, B, C and D, the monitoring program is installed in the cloud servers A, B, C and D. Furthermore, the cloud servers A, B, C and D are capable of direct communication with each other. For example, the cloud server A directly communicates with the cloud server B after the cloud servers A and B both install the monitoring program. The monitoring program obtains the CPU utilization rate of the cloud server 500, the voltage of the cloud server 500, the rotational speed of the fan of the cloud server 500, the temperature of the cloud server 500, the status of the cloud server 500 from the virtual machine management application.

In step S20, the assignment module 220 assigns an IP address using the DHCP service to each cloud server 500 of the data center 50 to communicate with each cloud server 500.

In step S30, the sending module 230 sends the monitoring program to the cloud servers 500 according to the configuration file and consists of a cloud server cluster. For example, if the configuration file includes four serial numbers of the cloud servers A, B, C and D, the sending module 230 sends the monitoring program to the cloud servers A, B, C and D. The monitoring program is installed into the cloud servers A, B, C and D and is activated to be available for use in the cloud servers A, B, C and D. The cloud server cluster is defined that each two of the cloud servers 500 are capable of directly communicating with each other using the monitoring program. For example, if the cloud server cluster is generated by the cloud servers A, B, C and D, the cloud server A directly communicate with B, C and D using the monitoring program, the cloud server B directly communicate with A, C and D using the monitoring program, the cloud server C directly communicate with A, B and D using the monitoring program, and the cloud server D directly communicate with A, B, and C using the monitoring program.

In step S40, the obtaining module 240 obtains parameters of each cloud server 500 from the cloud server cluster by the monitoring program. As mentioned above, the parameters of each cloud server 500 include the CPU utilization rate of the cloud server 500, the voltage of the cloud server 500, the rotational speed of the fan of the cloud server 500, the temperature of the cloud server 500, the status of the cloud server 500.

In step S50, the determination module 250 determines if the cloud server 500 in the cloud server cluster works abnormally according to the parameters. In one embodiment, if any one of the cloud server A, B, C or D works abnormally, the procedure goes to step S60. Otherwise, if all of the cloud servers in the cloud server cluster work normally, the procedure returns to step S40.

In step S60, the search module 260 searches for the image file corresponding to the virtual machine installed in the cloud server 500 from the remote computer, if the cloud server 500 works abnormally. For example, if the cloud server 500 installs the virtual machine all by the image file al, and the cloud server works abnormally, and the searching module searches for the image file al in the remote computer 20.

In step S70, the sending module 230 sends the searched image file to another cloud server 500 in the cloud server cluster and installs the virtual machine in another cloud server 500 according to the searched image file. For example, if the cloud server A works abnormally, the sending module 230 sends the searched image file to the cloud server B, and install the virtual machine in the cloud server B according to the searched image file. Additionally, the sending module 230 checks the parameters of another cloud server 500 to make sure that another cloud server 500 works normally and are not overloaded.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer, the remote computer in communication with cloud servers of a data center, the remote computer comprising:
a storage system storing a configuration file and one or more image files;
at least one processor; and
one or more programs stored in the storage system and being executable by the at least one processor, the one or more programs comprising:
a sending module sends the monitoring program to the cloud servers according to the configuration file and consists of a cloud server cluster using the monitoring program;
an obtaining module obtains parameters of each cloud server in the cloud server cluster by the monitoring program;
a determination module determines if the cloud server in the cloud server cluster works abnormally according to the parameters;
a search module searches for an image file corresponding to a virtual machine installed in the cloud server from the remote computer, if the cloud server works abnormally; and
a sending module sends the searched image file to another cloud server in the cloud server cluster and installs the virtual machine in another cloud server according to the searched image file.

2. The remote computer of claim 1, wherein the configuration file comprises serial numbers of the cloud servers.

3. The remote computer of claim 1, wherein the parameters of each cloud server comprise a CPU utilization rate of the cloud server, a voltage of the cloud server, a rotational speed of a fan of the cloud server, a temperature of the cloud server, and a status of the cloud server.

4. The remote computer of claim 1, wherein each two of the cloud servers in the cloud server cluster are capable of directly communicating with each other using the monitoring program.

5. The remote computer of claim 1, wherein each image file comprises an installation process of a virtual machine and an activation process of the virtual machine.

6. A computer-based installation method being performed by execution of computer readable program code by a processor of a remote computer, the remote computer in communication with cloud servers of a data center, the remote computer storing a configuration file and one or more image files, the method comprising:
sending the monitoring program to the cloud servers according to the configuration file and generating a cloud server cluster using the monitoring program;
obtaining parameters of each cloud server in the cloud server cluster by the monitoring program;
determining if the cloud server in the cloud server cluster works abnormally according to the parameters;
searching for an image file corresponding to a virtual machine installed in the cloud server from the remote computer, if the cloud server works abnormally; and
sending the searched image file to another cloud server in the cloud server cluster and installing the virtual machine in another cloud server according to the searched image file.

7. The method of claim 6, wherein the parameters of each cloud server comprise a CPU utilization rate of the cloud server, a voltage of the cloud server, a rotational speed of a fan of the cloud server, a temperature of the cloud server, and a status of the cloud server.

8. The method of claim 7, wherein the cloud server works abnormally upon the condition that the CPU utilization rate of the cloud server does not fall within a predetermined CPU utilization rate range.

9. The method of claim 7, wherein the cloud server works abnormally upon the condition that the voltage of the cloud server does not fall within a predetermined voltage range.

10. The method of claim 7, wherein the cloud server works abnormally upon the condition that the obtained rotational speed of the fan of the cloud server does not fall within a predetermined rotational speed range.

11. The method of claim 7, wherein the cloud server works abnormally upon the condition that the temperature of the cloud server does not fall within a temperature range.

12. The method of claim 7, wherein the cloud server works abnormally upon the condition that the cloud server is in a power-off state.

13. A non-transitory computer-readable medium having stored thereon instructions that, when executed by a remote computer, the remote computer in communication with cloud servers of a data center, the remote computer storing a configuration file and one or more image files, causing the remote computer to perform a monitoring method, the method comprising:
sending the monitoring program to the cloud servers according to the configuration file and generating a cloud server cluster using the monitoring program;
obtaining parameters of each cloud server in the cloud server cluster by the monitoring program;
determining if the cloud server in the cloud server cluster works abnormally according to the parameters;
searching for an image file corresponding to a virtual machine installed in the cloud server from the remote computer, if the cloud server works abnormally; and
sending the searched image file to another cloud server in the cloud server cluster and installing the virtual machine in another cloud server according to the searched image file.

14. The non-transitory medium of claim 13, wherein the parameters of each cloud server comprise a CPU utilization rate of the cloud server, a voltage of the cloud server, a rotational speed of a fan of the cloud server, a temperature of the cloud server, and a status of the cloud server.

15. The non-transitory medium of claim 14, wherein the cloud server works abnormally upon the condition that the CPU utilization rate of the cloud server does not fall within a predetermined CPU utilization rate range.

16. The non-transitory medium of claim 14, wherein the cloud server works abnormally upon the condition that the voltage of the cloud server does not fall within a predetermined voltage range.

17. The non-transitory medium of claim 14, wherein the cloud server works abnormally upon the condition that the obtained rotational speed of the fan of the cloud server does not fall within a predetermined rotational speed range.

18. The non-transitory medium of claim 14, wherein the cloud server works abnormally upon the condition that the temperature of the cloud server does not fall within a temperature range.

19. The non-transitory medium of claim 14, wherein the cloud server works abnormally upon the condition that the cloud server is in a power-off state.

20. The non-transitory medium of claim 13, wherein each two of the cloud servers in the cloud server cluster are capable of directly communicating with each other using the monitoring program.
